(19) United States
(12) Patent Application Publication
(10) Pub. No.: US 2017/0308240 A1
(43) Pub. Date: Oct. 26, 2017

(54) PRESSURE SENSING TOUCH DISPLAY DEVICE

(71) Applicant: eGalax_eMPIA Technology Inc., Taipei (TW)

(72) Inventors: Shang-Tai YEH, Taipei (TW); Hsiao-Tsung LEE, Taipei (TW)

(21) Appl. No.: 15/491,163

(22) Filed: Apr. 19, 2017

Related U.S. Application Data
(60) Provisional application No. 62/325,142, filed on Apr. 20, 2016.

(51) Int. Cl. G06F 3/041; G02F 1/1333; G02F 1/1335; G02F 1/1343; G02F 1/1368; G06F 3/044

(52) U.S. Cl. CPC G06F 3/0418; G02F 1/1368; G02F 1/13338; G06F 3/044; G06F 3/0412; G02F 1/133345; G02F 1/134363; G02F 1/133514; G02F 2201/121; G06F 2203/04105

(57) ABSTRACT

A pressure sensing touch display device includes a control unit, and a display screen, which is electrically connected to the control unit, including a display panel having a common electrode layer, a touch panel having a touch sensing layer and a spacer layer bonded between the common electrode layer of the display panel and the touch sensing layer of touch panel and defining therein a sensing space in communication between the common electrode layer and the touch sensing layer for creating a capacitive coupling sensible by the touch sensing layer upon a touch of an external conductive pressure object.

### CROSS REFERENCE TO RELATED APPLICATIONS

This application claims priority of U.S. Provisional Application No. 62/325,142 filed on Apr. 20, 2016 under 35 U.S.C. §119(e), the entire contents of all of which are hereby incorporated by reference.

### BACKGROUND OF THE INVENTION

### 1. Field of the Invention

The present invention relates to touch control technology and more particularly, to a pressure sensing touch display device, which comprises a display screen that comprises a display panel having a common electrode layer located on one surface thereof, a touch panel having a touch sensing layer located on one surface thereof and a spacer layer bonded between the common electrode layer and the touch sensing layer, and a control unit electrically connected with the display screen for calculating the capacitive coupling produced by the touch sensing layer and the common electrode layer upon the touch of an external conductive pressure object on the touch panel to identify the touched location accurately.

### 2. Description of the Related Art

With the development of the innovation of high technology electronic products, a variety of electronic products such as desk computers, notebook computers, mobile phones, auto teller machines, etc. have been created and widely used in our daily life. In the early days, most electronic products use a physical keyboard for the input of control instruction or signal to initiate system startup. However, some electronic products have a small size with minimized physical input keys. When clicking these minimized physical input keys, the user may inadvertently click a wrong key, leading to considerable trouble and inconvenience in input operation. In recent years, touch screen has been intensively used in smart electronic products such as smart phone, tablet computer, auto teller machine, commercial kiosk machine, etc. to substitute for physical keyboard for data input. A user can use a finger or stylus to touch a particular location within the display area of the touch screen, initiating an internal controller of the touch screen-based electronic product to run the related software. Commercial touch screens include two types, namely, the capacitive type and the resistive type. When a finger, stylus or any other conductive object touches or approaches the touch screen, the internal capacitance value of the touch screen is changed. This change in capacitance value is then detected by the internal controller for determination of the location of the touch on the touch screen and execution of the related action.

When the voltage of the drive signal of the touch screen is high, the touch controller can accurately detect the signal, but when the voltage of the drive signal of the touch screen is low, the touch controller cannot detect the signal to accurately determine the location of the touched point, thus, the touch screen touch detection accuracy of the touch controller is reduced.

The touch panels of commercial touch screens can detect a change in physical quantity, such as capacitance value upon approach of an external object to the touch panel, and then calculate such a physical quantity change to determine the location of the external object, and then provide a signal indicative of the touched location to the touch controller. These commercial touch screens enable the touch controller to calculate the pressure given by the external object to the touch panel. However, the size of the touch area on the touch panel can significantly affect the generation of the capacitive, lowering the accuracy of the determination of the touch location and causing the touch controller to produce a misjudgment. In actual application, the touch controller cannot accurately detect the pressure value of the touched location, and thus, the user cannot take full advantage of the touch screen.

Therefore, how to solve the inaccuracy capacitance value detection problem of conventional touch screens is the direction of study the manufacturers in the touch screen industry need to face.

### SUMMARY OF THE INVENTION

The present invention has been accomplished under the circumstances in view. It is therefore the main object of the present invention to provide a pressure sensing touch display device, which accurately detects the location of the touch of an external conductive pressure object on the touch panel by detecting and calculating a change in capacitive coupling upon the touch of the external conductive pressure object on the touch panel.

To achieve this and other objects of the present invention, a pressure sensing touch display device comprises a control unit and a display screen electrically connected to the control unit. The display screen includes a display panel having a common electrode layer, a touch panel having a touch sensing layer and a spacer layer bonded between the common electrode layer of the display panel and the touch sensing layer of touch panel and defining therein a sensing space in communication between the common electrode layer and the touch sensing layer for creating a capacitive coupling sensible by the touch sensing layer upon a touch of an external conductive pressure object. Thus, when an external conductive pressure object touches the touch panel, the control unit detects a change in the capacitive coupling for the determination of the touched location accurately, avoiding misjudgment.

To achieve this and other objects of the present invention, a pressure sensing touch display device comprises a control unit and a display screen electrically connected to the control unit. The display screen comprises a display panel, an elastically deformable insulation layer and a touch panel. The display panel comprises a common electrode layer located on one surface thereof and bonded to one surface of the elastically deformable insulation layer. The touch panel comprises a touch sensing layer located on an inner surface thereof and bonded to an opposite surface of the elastically deformable insulation layer opposite to the common electrode layer. The elastically deformable insulation layer is bonded between the common electrode layer and the touch sensing layer, and capable of generating a capacitive coupling for sensing by the touch sensing layer upon a touch of an external conductive pressure object on the touch panel.

To achieve this and other objects of the present invention, a pressure sensing touch display device comprises a control unit and a display screen electrically connected to the control unit. The display screen comprises an In-Plane-Switching (IPS) display panel and a first touch sensing layer. The In-Plane-Switching (IPS) display panel comprises a bottom substrate, an upper substrate, a liquid crystal layer bonded between the upper substrate and the bottom substrate, and a first common electrode layer bonded between the bottom substrate and the liquid crystal layer for enabling a capacitive coupling to be created between the first touch sensing layer and the first common electrode layer upon a touch of an external conductive pressure object on the display screen.

To achieve this and other objects of the present invention, a pressure sensing touch display device comprises a control unit and a display screen electrically connected to the control unit. The display screen comprises a first display panel, a second touch sensing layer, a first elastically deformable insulation layer bonded between the first display panel and the second touch sensing layer, a second common electrode layer bonded between the upper substrate and the bottom substrate, and a first common electrode layer bonded between the first display panel and the first elastically deformable insulation layer for allowing generation of a capacitive coupling between the second touch sensing layer and the second common electrode layer of the first display panel when the second touch sensing layer is touched by an external conductive pressure object.

Other advantages and features of the present invention will be fully understood by reference to the following specification in conjunction with the accompanying drawings, in which like reference signs denote like components of structure.

### BRIEF DESCRIPTION OF THE DRAWINGS

FIG. 1 is a schematic drawing illustrating the architecture of a pressure sensing touch display device in accordance with the present invention.

FIG. 2 is a simple circuit block diagram of the pressure sensing touch display device in accordance with the present invention is shown.

FIG. 3 is a schematic side view of the pressure sensing touch display device in accordance with the first embodiment of the present invention is shown.

FIG. 4 is a schematic side view of the first embodiment of the present invention before a touch.

FIG. 5 corresponds to FIG. 4, illustrating a finger touched the touch panel.

FIG. 6 is a schematic side view of a pressure sensing touch display device in accordance with a second embodiment of the present invention is shown.

FIG. 7 corresponds to FIG. 6, illustrating a finger touched the touch panel.

FIG. 8 is a schematic side view of a pressure sensing touch display device in accordance with a third embodiment of the present invention is shown.

FIG. 9 corresponds to FIG. 8, illustrating a finger touched the touch panel.

FIG. 10 is a simple circuit block diagram of the pressure sensing touch display device in accordance with the third embodiment of the present invention is shown.

FIG. 11 is a schematic side view of a pressure sensing touch display device in accordance with a fourth embodiment of the present invention is shown.

FIG. 12 corresponds to FIG. 11, illustrating a finger touched the touch panel.

FIG. 13 is a simple circuit block diagram of the pressure sensing touch display device in accordance with the fourth embodiment of the present invention is shown.

### DETAILED DESCRIPTION OF THE PREFERRED EMBODIMENT

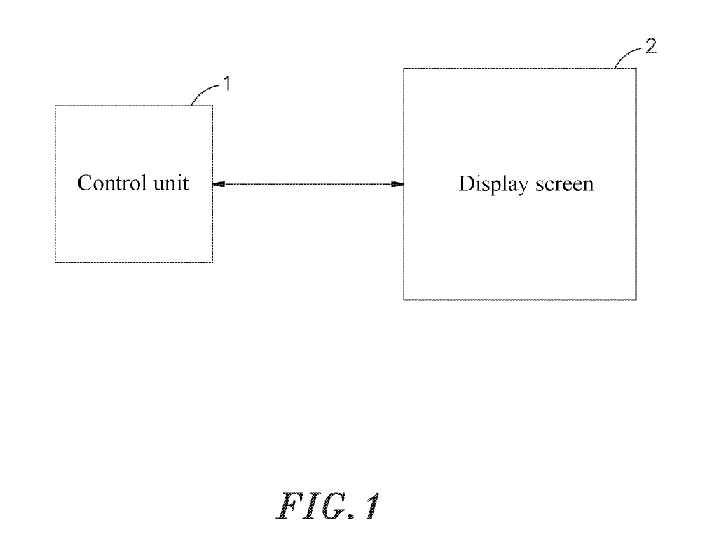

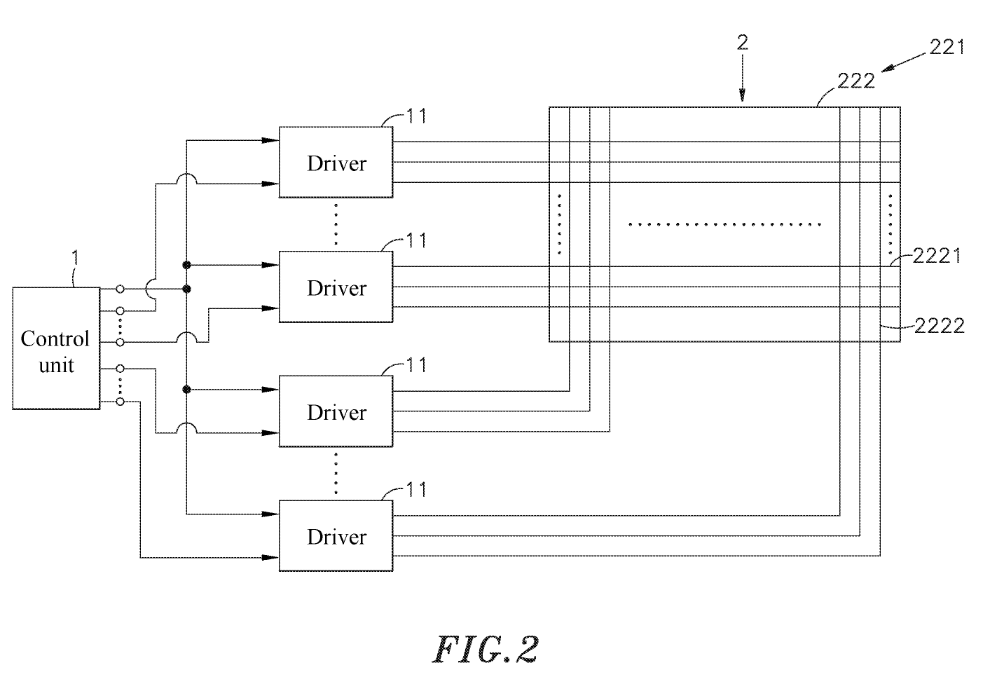

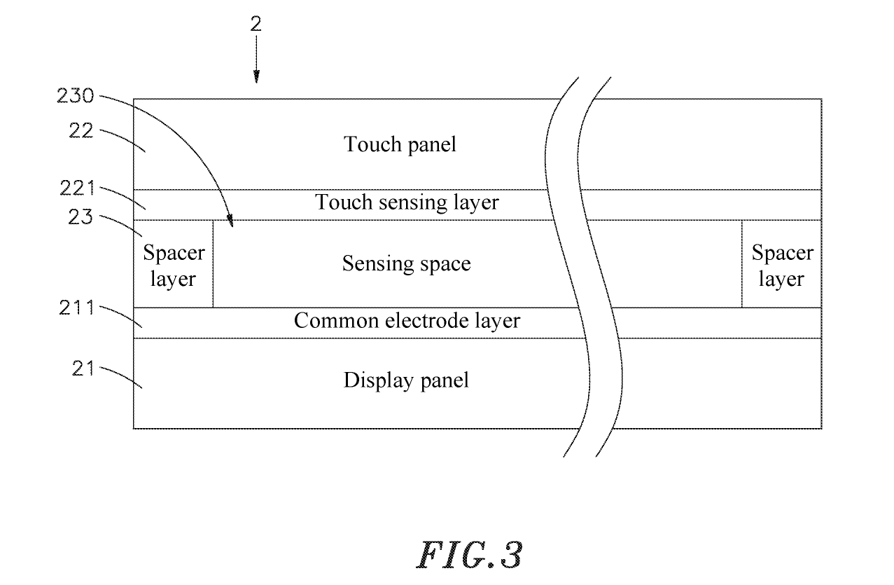

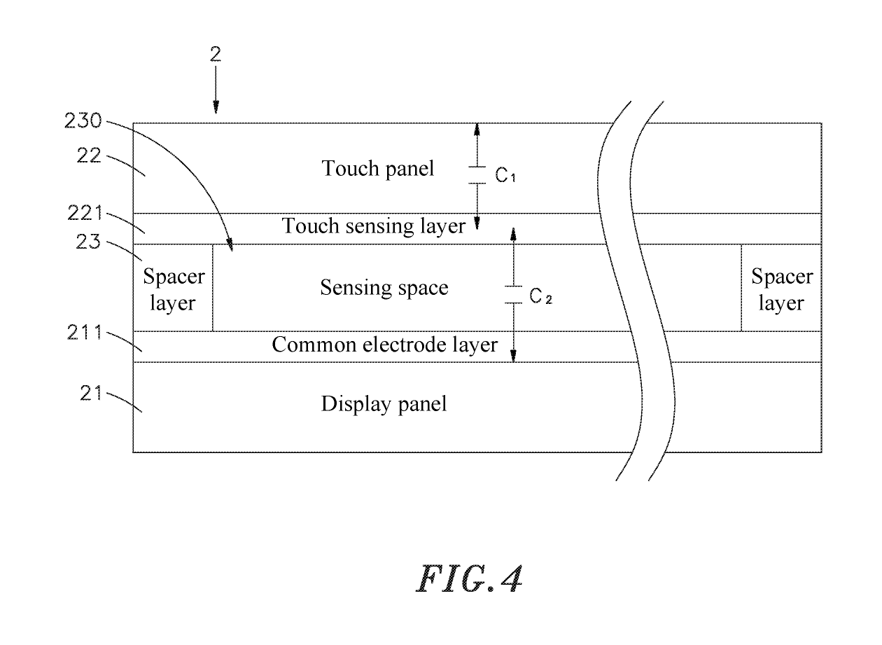

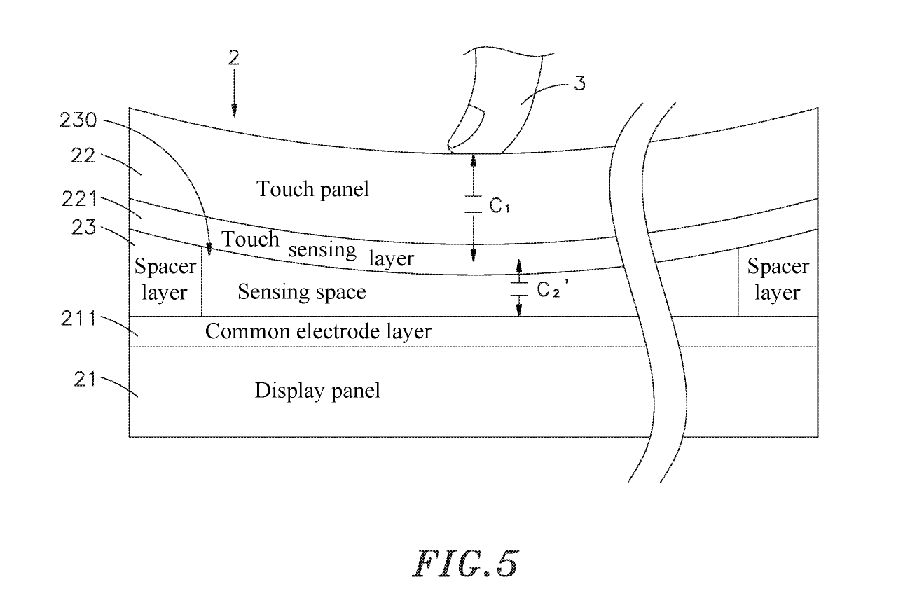

Referring to FIGS. 1-5, a pressure sensing touch display device in accordance with a first embodiment of the present invention is shown. The pressure sensing touch display device comprises a control unit 1 and a display screen 2.

The control unit 1 is electrically connected with the display screen 2 and adapted for processing signals provided by the display screen 2.

The display screen 2 comprises a display panel 21 having a common electrode layer 211 located on one surface thereof, a touch panel 22 having a touch sensing layer 221 located on one surface thereof and facing toward the common electrode layer 211 of the display panel 21, and a spacer layer 23 bonded between the common electrode layer 211 and the touch sensing layer 221 and defining therein a sensing space 230 in communication between the common electrode layer 211 and the touch sensing layer 221.

The display panel 21 of the display screen 2 can be a LCD panel, color filter (CF) or thin film transistor (TFT) substrate. The common electrode layer 211 of the display panel 21 is electrically connected to the grounding terminal of the circuit layout (not shown) of the display panel 21. The touch panel 22 is a pressure sensing touch display panel. The touch sensing layer 221 of the touch panel 22 comprises at least one electrode layer 222 electrically connected to the control unit 1. The electrode layer 222 comprises a plurality of driving electrodes 2221 arranged in parallel, and a plurality of sensing electrodes 2222 arranged in parallel. The driving electrodes 2221 and the sensing electrodes 2222 are cross-arranged in the longitudinal and transverse directions, enabling multiple drivers 11 of the control unit 1 to drive the respective driving electrodes 2221 of the electrode layer 222 in generating a driving signal so that the sensing electrodes 2222 can detect the capacitance coupling of the respective driving electrodes 2221.

When the touch panel 22 of the display screen 2 is touched by an external conductive pressure object 3 (finger or stylus), the touch sensing layer 221 detect the capacitive coupling (C1) between the touch panel 22 and the conductive pressure object 3 for determining the location on the touch panel 22 that is touched by the conductive pressure object 3. At the same time, a capacitive coupling (C2) is produced in the sensing space 230 between the touch sensing layer 221 and the common electrode layer 211 of the display panel 21. When the conductive pressure object 3 gives a further pressure to the touch panel 22 to elastically deform the touch panel 22 and the touch sensing layer 221 downwards and to cause a capacitive coupling (C2′) between the touch sensing layer 221 and the common electrode layer 211, the capacitive coupling signals (C1,C2,C2′) are provided to the control unit 1, and thus, the control unit 1 can determine the touch location of the conductive pressure object 3 on the touch panel 22 according to the capacitive coupling change (C1), and calculate the amount of the pressure been applied by the conductive pressure object 3 to the touch panel 22 according to the capacitive coupling (C2,C2′) between the common electrode layer 211 and the touch sensing layer 221 and then provide a signal to an electronic device (notebook computer, tablet computer or smart phone) according to the calculation result for the implementation of a specific function (such as toggle the screen, power on, or power off).

The control unit 1 can also detect the capacitive coupling (C1) between the touch panel 22 and the conductive pressure object 3 and the capacitive coupling (C2,C2′) between the common electrode layer 211 and the touch sensing layer 221 at different time points, determining the location and time where the conductive pressure object 3 touched the touch panel 22.

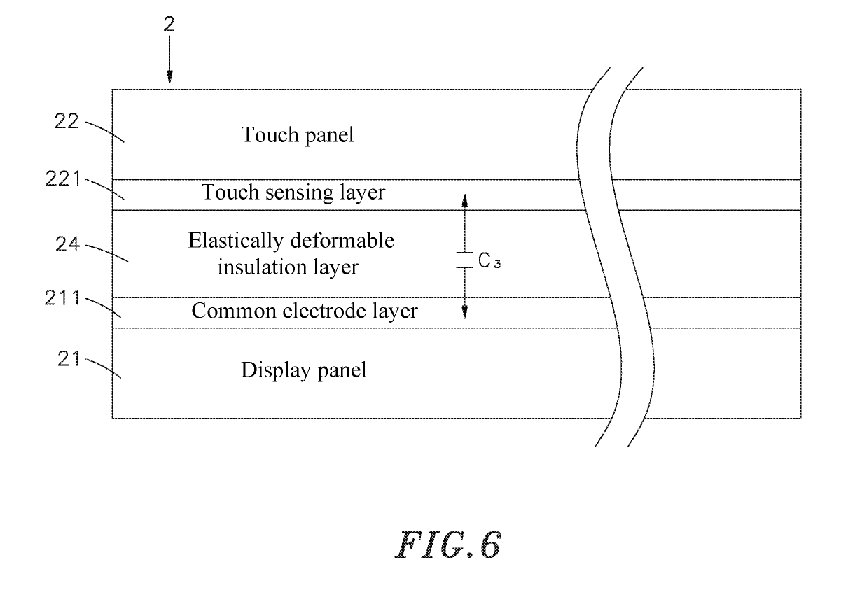

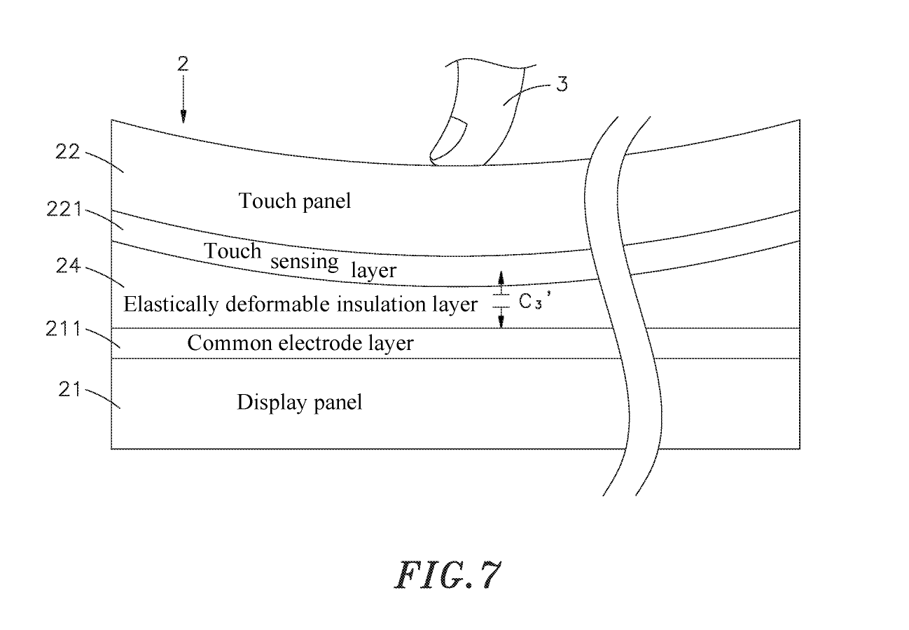

Referring to FIGS. 6 and 7 and FIGS. 1 and 2 again, a pressure sensing touch display device in accordance with a second embodiment of the present invention is shown. As illustrated, the pressure sensing touch display device in accordance with this second embodiment comprises a control unit 1 and a display screen 2. The display screen 2 comprises a display panel 21 having a common electrode layer 211 located on one surface thereof, a touch panel 22 having a touch sensing layer 221 located on one surface thereof and facing toward the common electrode layer 211 of the display panel 21, and an elastically deformable insulation layer 24 bonded between the common electrode layer 211 and the touch sensing layer 221. The elastically deformable insulation layer 24 is made from a transparent elastic material such as optical adhesive or silicon rubber, or a compressible material. The elastically deformable insulation layer 24 between the common electrode layer 211 and the touch sensing layer 221 provides a capacitive coupling (C3). When the touch panel 22 is touched by an external conductive pressure object 3 (finger or stylus), the touch panel 22 and the touch sensing layer 221 are deformed with the elastically deformable insulation layer 24, causing a change in the capacitive coupling (C3′) between the touch sensing layer 221 and the common electrode layer 211. The control unit 1 can then calculate the pressure of the conductive pressure object 3 on the touch panel 22 according to the capacitive coupling (C3′) between the common electrode layer 211 and the touch sensing layer 221, and then provide a signal to an electronic device (notebook computer, tablet computer or smart phone) according to the calculation result for the implementation of a specific function (such as toggle the screen, power on, or power off).

Further, the display panel 21 can be a LCD panel, a color filter (CF), or a thin film transistor (TFT) substrate. Further, the common electrode layer 211 of the display panel 21 is electrically connected to the grounding terminal of the circuit layout (not shown) of the display panel 21. The touch panel 22 is a pressure sensing touch display device. The touch sensing layer 221 of the touch panel 22 comprises at least one electrode layer 222 electrically connected to the control unit 1. The electrode layer 222 comprises a plurality of driving electrodes 2221 arranged in parallel, and a plurality of sensing electrodes 2222 arranged in parallel. The driving electrodes 2221 and the sensing electrodes 2222 are cross-arranged in the longitudinal and transverse directions, enabling multiple drivers 11 of the control unit 1 to drive the respective driving electrodes 2221 of the electrode layer 222 in generating a driving signal so that the sensing electrodes 2222 can detect the capacitance coupling capacitive coupling (C3,C3′) of the respective driving electrodes 2221.

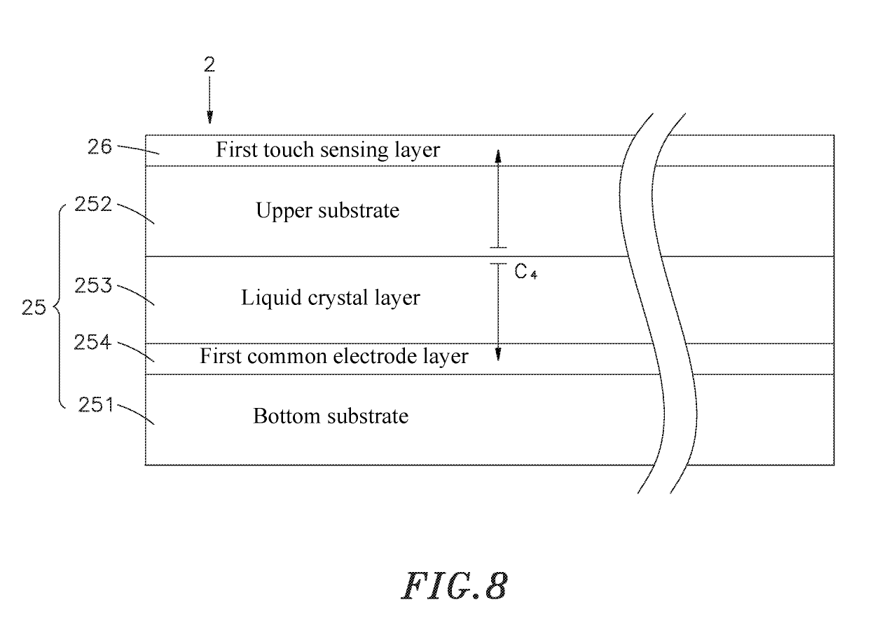

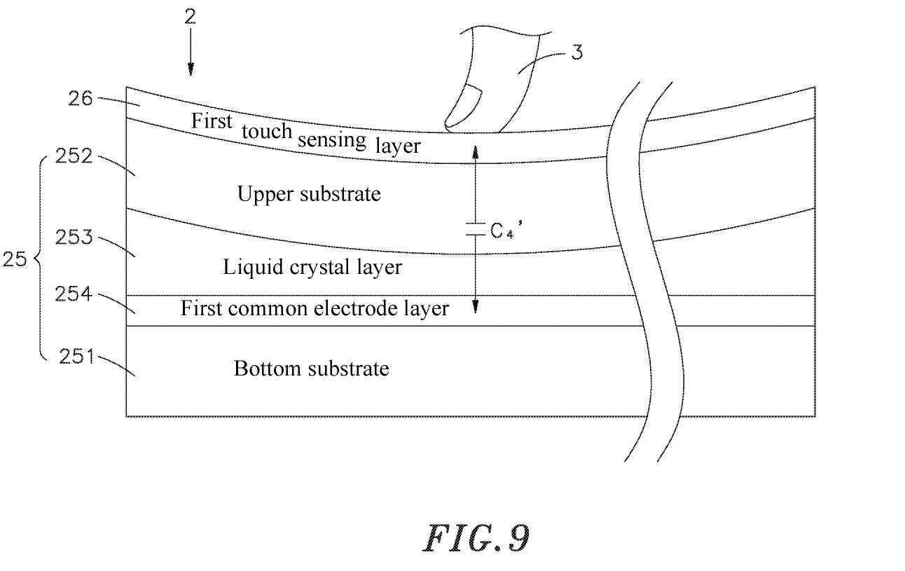

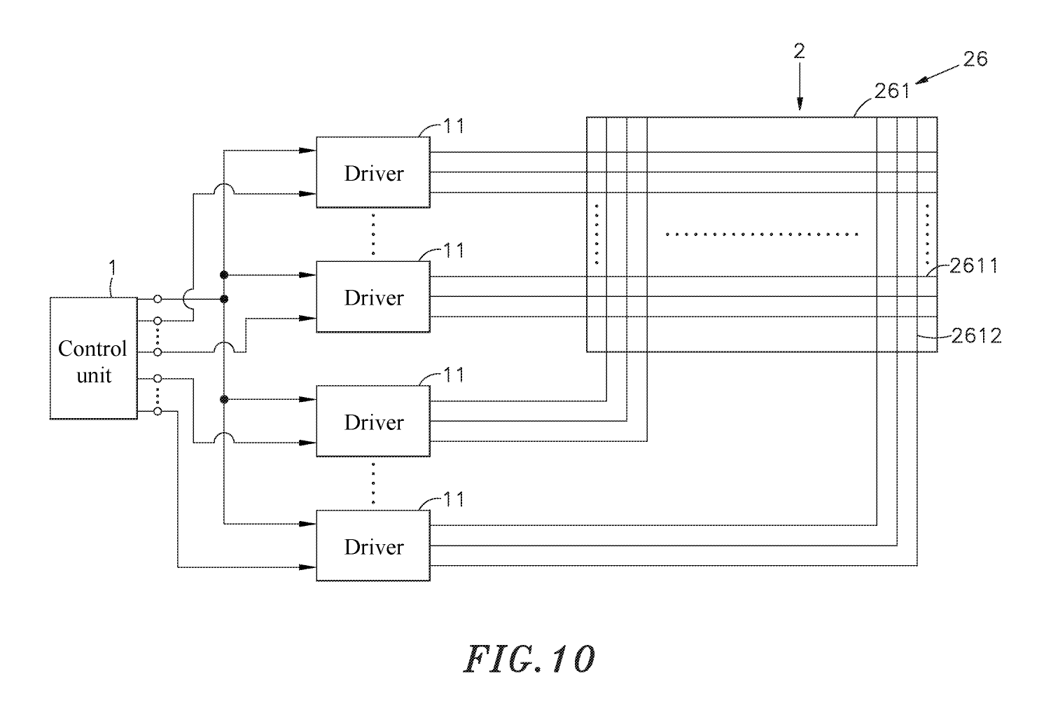

Referring to FIGS. 8, 9 and 10 and FIGS. 1 and 2 again, a pressure sensing touch display device in accordance with a third embodiment of the present invention is shown. As illustrated, the pressure sensing touch display device in accordance with this third embodiment comprises a control unit 1 and a display screen 2. The display screen 2 comprises an In-Plane-Switching (IPS) display panel 25 and a first touch sensing layer 26. The In-Plane-Switching (IPS) display panel 25 comprises a bottom substrate 251, an upper substrate 252, a liquid crystal layer 253 bonded between the upper substrate 252 and the bottom substrate 251, and a first common electrode layer 254 bonded between the bottom substrate 251 and the liquid crystal layer 253. Thus, a capacitive coupling (C4) is created between the first touch sensing layer 26 and the first common electrode layer 254. When a conductive pressure object 3 (finger or stylus) touches the first touch sensing layer 26 of the display screen 2, the first touch sensing layer 26, the upper substrate 252 and the liquid crystal layer 253 are elastically deformed, enabling the control unit 1 to detect the capacitive coupling (C4′) generated due to deformation of the first touch sensing layer 26, first common electrode layer 254 and liquid crystal layer 253 of the display screen 2. Thus, the control unit 1 can calculate the amount of pressure applied by the conductive pressure object 3 to the In-Plane-Switching (IPS) display panel 25 according to the capacitive coupling (C4,C4′) created in the first touch sensing layer 26, first common electrode layer 254 and liquid crystal layer 253 of the display screen 2, and then provide a signal to an electronic device (notebook computer, tablet computer or smart phone) according to the calculation result for the implementation of a specific function (such as toggle the screen, power on, or power off).

Further, the In-Plane-Switching (IPS) display panel 25 can be a pressure sensing touch display panel. Further, the first touch sensing layer 26 comprises at least one first electrode layer 261 electrically connected to the control unit 1. Further, the first electrode layer 261 comprises a plurality of first driving electrodes 2611 arranged in parallel, and a plurality of first sensing electrodes 2612 arranged in parallel. The first driving electrodes 2611 and the first sensing electrodes 2612 are cross-arranged in the longitudinal and transverse directions, enabling multiple drivers 11 of the control unit 1 to drive the respective first driving electrodes 2611 of the first electrode layer 261 in generating a driving signal so that the first sensing electrodes 2612 can detect the capacitive coupling (C4,C4′) of the respective first driving electrodes 2611.

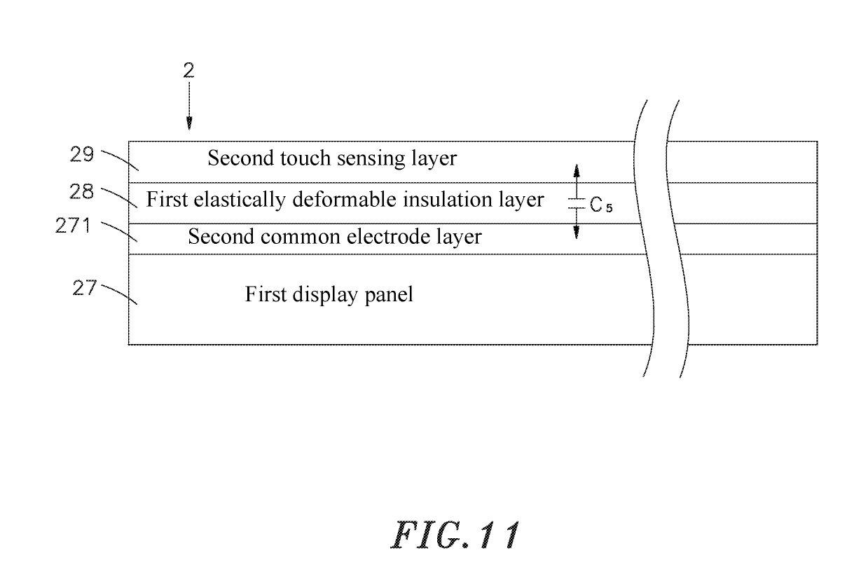

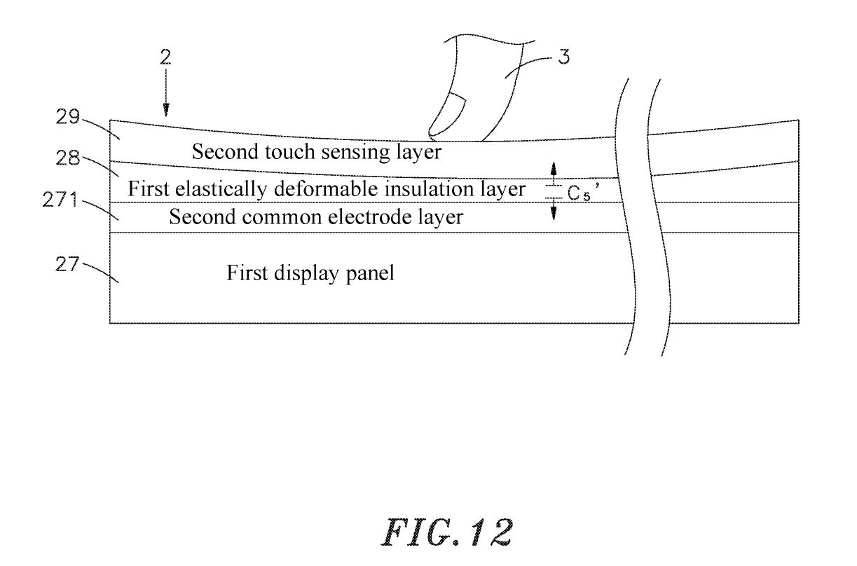

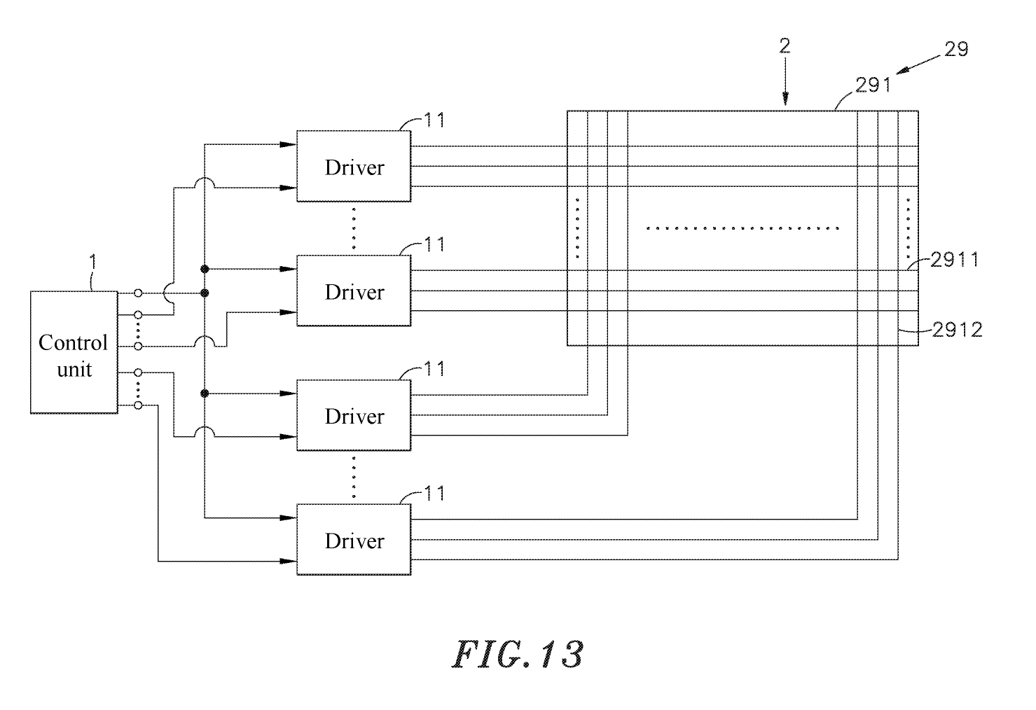

Referring to FIGS. 11, 12 and 13 and FIGS. 1 and 2 again, a pressure sensing touch display device in accordance with a fourth embodiment of the present invention is shown. As illustrated, the pressure sensing touch display device in accordance with this fourth embodiment comprises a control unit 1 and a display screen 2. The display screen 2 comprises a first display panel 27, a second touch sensing layer 29, a first elastically deformable insulation layer 28 bonded between the first display panel 27 and the second touch sensing layer 29, a second common electrode layer 271 bonded between the upper substrate 252 and the bottom substrate 251, and a first common electrode layer 254 bonded between the first display panel 27 and the first elastically deformable insulation layer 28. Thus, a capacitive coupling (C5) is created between the second touch sensing layer 29 and the surface of the second common electrode layer 271 of the first display panel 27. When the second touch sensing layer 29 is touched by an external conductive pressure object 3 (finger or stylus), the control unit 1 detects the capacitive coupling (C5,C5′) created in the first elastically deformable insulation layer 28 and second common electrode layer 271 of the display screen 2, calculates the amount of pressure given by the conductive pressure object 3 to the second touch sensing layer 29 according to the detected capacitive coupling (C5,C5′), and then provides a signal to an electronic device (notebook computer, tablet computer or smart phone) according to the calculation result for the implementation of a specific function (such as toggle the screen, power on, or power off).

Further, the first display panel 27 can be a LCD panel, a color filter (CF), or a thin film transistor (TFT) substrate. Further, the second common electrode layer 271 is electrically connected to the grounding terminal of the circuit layout (not shown) of the first display panel 27. Further, the second touch sensing layer 29 consists of multiple thin films, and is bonded with the first elastically deformable insulation layer 28 the surface of the second common electrode layer 271 of the first display panel 27. Further, the second touch sensing layer 29 comprises at least one second electrode layer 291. The at least one second electrode layer 291 is electrically connected to the control unit 1. Further, the second electrode layer 291 comprises a plurality of second driving electrodes 2911 arranged in parallel, and a plurality of second sensing electrodes 2912 arranged in parallel. The second driving electrodes 2911 and the second sensing electrodes 2912 are cross-arranged in the longitudinal and transverse directions, enabling multiple drivers 11 of the control unit 1 to drive the respective second driving electrodes 2911 of the second electrode layer 291 in generating a driving signal so that the second sensing electrodes 2912 can detect the capacitive coupling (C5,C5′) of the second driving electrodes 2911.

As described above, the control unit 1 of the pressure sensing touch display device is electrically connected to the display screen 2; the common electrode layer 211 of the display panel 21 of the display screen 2 faces toward the touch sensing layer 221 of touch panel 22. When the surface of the touch panel 22 is touched by an external conductive pressure object 3, a capacitance coupling is created between the conductive pressure object 3 and the touch sensing layer 221, and another capacitive coupling is created between the touch sensing layer 221 the common electrode layer 211, and thus, the control unit 1 can determine the touch location on the touch panel 22 and the amount of pressure of the touch according to the detected two capacitance couplings, and then outputs a corresponding signal indicative of the touched location and pressure to a predetermined electronic device for a corresponding control.

In conclusion, the invention provides a pressure sensing touch display device, which comprises a display screen, and a control unit electrically connected with the display screen. The control unit is adapted for processing signals generated by the display screen. The display screen comprises a display panel, a touch panel and a spacer layer bonded between the display panel and the touch panel. The display panel comprises a common electrode layer bonded to one surface of the spacer layer. The touch panel comprises a touch sensing layer bonded to an opposite surface of the spacer layer. Further, the spacer layer defines therein a sensing space in communication between the common electrode layer and the touch sensing layer for creating a capacitive coupling sensible by the touch sensing layer. Thus, when the surface of the touch panel is touched by an external conductive pressure object, the value of the capacitive coupling between the touch sensing layer and the common electrode layer is relatively changed. The control unit calculates the change in the capacitive coupling to accurately identify the location of the touched point on the touch panel, and then outputs a corresponding signal indicative of the touched location to a predetermined electronic device for a corresponding control.

Although a particular embodiment of the invention has been described in detail for purposes of illustration, various modifications and enhancements may be made without departing from the spirit and scope of the invention. Accordingly, the invention is not to be limited except as by the appended claims.

What the invention claimed is:

1. A pressure sensing touch display device, comprising a display screen, and a control unit electrically connected with said display screen, wherein:
said control unit is adapted for processing signals generated by said display screen;
said display screen comprises a display panel, a touch panel and a spacer layer bonded between said display panel and said touch panel, said display panel comprising a common electrode layer bonded to one surface of said spacer layer, said touch panel comprising a touch sensing layer bonded to an opposite surface of said spacer layer, said spacer layer defining therein a sensing space in communication between said common electrode layer and said touch sensing layer for creating a capacitive coupling sensible by said touch sensing layer.

2. The pressure sensing touch display device as claimed in claim 1, wherein said display panel is selected from the group of LCD panel, color filter (CF) and thin film transistor (TFT) substrate; said common electrode layer of said display panel is electrically connected to a grounding terminal of a circuit layout of said display panel.

3. The pressure sensing touch display device as claimed in claim 1, wherein said touch panel is a pressure sensing touch display device; said touch sensing layer of touch panel comprises at least one electrode layer electrically connected to said control unit, said electrode layer comprises a plurality of driving electrodes arranged in parallel and a plurality of sensing electrodes arranged in parallel, said driving electrodes and said sensing electrodes being cross-arranged in longitudinal and transverse directions; said control unit further comprises a plurality of drivers adapted for driving the respective said driving electrodes of said electrode layer in generating a driving signal so that said sensing electrodes are capable of detecting the capacitance coupling induced by the respective said driving electrodes.

4. A pressure sensing touch display device, comprising a display screen, and a control unit electrically connected with said display screen, wherein:
said control unit is adapted for processing signals generated by said display screen;
said display screen comprises a display panel, an elastically deformable insulation layer and a touch panel, said display panel comprising a common electrode layer located on one surface thereof and bonded to one surface of said elastically deformable insulation layer, said touch panel comprising a touch sensing layer located on an inner surface thereof and bonded to an opposite surface of said elastically deformable insulation layer opposite to said common electrode layer, said elastically deformable insulation layer being bonded between said common electrode layer and said touch sensing layer and capable of generating a capacitive coupling for sensing by said touch sensing layer upon a touch of an external conductive pressure object on said touch panel.

5. The pressure sensing touch display device as claimed in claim 4, wherein said display panel is selected from the group of LCD panel, color filter (CF) and thin film transistor (TFT) substrate; said common electrode layer of said display panel is electrically connected to a grounding terminal of a circuit layout of said display panel.

6. The pressure sensing touch display device as claimed in claim 4, wherein said touch panel is a pressure sensing touch display device; said touch sensing layer of touch panel comprises at least one electrode layer electrically connected to said control unit, said electrode layer comprises a plurality of driving electrodes arranged in parallel and a plurality of sensing electrodes arranged in parallel, said driving electrodes and said sensing electrodes being cross-arranged in longitudinal and transverse directions; said control unit further comprises a plurality of drivers adapted for driving the respective said driving electrodes of said electrode layer in generating a driving signal so that said sensing electrodes are capable of detecting the capacitance coupling induced by the respective said driving electrodes.

7. The pressure sensing touch display device as claimed in claim 4, wherein said elastically deformable insulation layer is selectively made from a transparent elastic material of optical adhesive or silicon rubber, or a compressible material.

8. A pressure sensing touch display device, comprising a display screen, and a control unit electrically connected with said display screen, wherein:
said control unit is adapted for processing signals generated by said display screen;
said display screen comprises an In-Plane-Switching (IPS) display panel and a first touch sensing layer, said In-Plane-Switching (IPS) display panel comprising a bottom substrate, an upper substrate, a liquid crystal layer bonded between said upper substrate and said bottom substrate and a first common electrode layer bonded between said bottom substrate and said liquid crystal layer for enabling a capacitive coupling to be created between said first touch sensing layer and said first common electrode layer upon a touch of an external conductive pressure object on said display screen.

9. The pressure sensing touch display device as claimed in claim 8, wherein said first touch sensing layer of said display screen comprises at least one first electrode layer electrically connected to said control unit, each said first electrode layer comprising a plurality of first driving electrodes arranged in parallel and a plurality of first sensing electrodes arranged in parallel, said first driving electrodes and said first sensing electrodes being cross-arranged in longitudinal and transverse directions; said control unit further comprises a plurality of drivers adapted for driving the respective said first driving electrodes of said first electrode layer in generating a driving signal so that said first sensing electrodes are capable of detecting the capacitance coupling induced by the respective said first driving electrodes for enabling said control unit to determine the amount of pressure of the touch on said display screen.

10. A pressure sensing touch display device, comprising a display screen, and a control unit electrically connected with said display screen, wherein:
said control unit is adapted for processing signals generated by said display screen;
said display screen comprises a first display panel, a second touch sensing layer, a first elastically deformable insulation layer bonded between said first display panel and said second touch sensing layer, a second common electrode layer bonded between said upper substrate and said bottom substrate and a first common electrode layer bonded between said first display panel and said first elastically deformable insulation layer for allowing generation of a capacitive coupling between said second touch sensing layer and said second common electrode layer of said first display panel when said second touch sensing layer is touched by an external conductive pressure object.

11. The pressure sensing touch display device as claimed in claim 10, wherein said display panel is selected from the group of LCD panel, color filter (CF) and thin film transistor (TFT) substrate; said common electrode layer of said display panel is electrically connected to a grounding terminal of a circuit layout of said display panel.

12. The pressure sensing touch display device as claimed in claim 10, wherein said first elastically deformable insulation layer is selectively made from a transparent elastic material of optical adhesive or silicon rubber, or a compressible material.

13. The pressure sensing touch display device as claimed in claim 10, wherein said second touch sensing layer consists of multiple thin films bonded with said first elastically deformable insulation layer to said second common electrode layer opposite to said first display panel.

14. The pressure sensing touch display device as claimed in claim 10, wherein said second common electrode layer is electrically connected to a grounding terminal of a circuit layout of said first display panel; said second touch sensing layer comprises at least one second electrode layer electrically connected to said control unit, each said second electrode layer comprising a plurality of second driving electrodes arranged in parallel, and a plurality of second sensing electrodes arranged in parallel, said second driving electrodes and said second sensing electrodes being cross-arranged in the longitudinal and transverse directions; said control unit comprises a plurality of drivers adapted for driving the respective said second driving electrodes of said second electrode layer in generating a driving signal so that said control unit detects the capacitive coupling created in said first elastically deformable insulation layer and second common electrode layer of said display screen when said second touch sensing layer is touched by an external conductive pressure object, and then calculates the amount of pressure given by the said conductive pressure object to said second touch sensing layer according to the detected capacitive coupling.
